(19) United States
(12) Patent Application Publication
(10) Pub. No.: US 2022/0210852 A1
(43) Pub. Date: Jun. 30, 2022

(54) USER EQUIPMENT AND RADIO BASE STATION

(71) Applicant: NTT DOCOMO, INC., Tokyo (JP)

(72) Inventors: Tooru Uchino, Tokyo (JP); Hideaki Takahashi, Chiyoda-ku, Tokyo (JP); Akihito Hanaki, Chiyoda-ku, Tokyo (JP)

(73) Assignee: NTT DOCOMO, INC., Tokyo (JP)

(21) Appl. No.: 17/601,295

(22) PCT Filed: Apr. 5, 2019
(86) PCT No.: PCT/JP2019/015234

§ 371 Date: Oct. 4, 2021

(51) Int. Cl. H04W 76/15; H04W 76/20; H04W 48/20

(52) U.S. Cl. CPC H04W 76/15; H04W 48/20; H04W 76/20

(57) ABSTRACT

A UE determines whether or not a gNB different from an eNB to which the UE is connected retains related information indicating a situation of the UE. The UE transmits a connection request with the gNB to the gNB even in a case where the gNB does not retain the related information.

### TECHNICAL FIELD

The present invention relates to a user equipment and a radio base station.

### BACKGROUND ART

The 3rd generation partnership project (3GPP) specifies Long Term Evolution (LTE), and specifies LTE-Advanced (hereinafter referred to as LTE including LTE-Advanced) for the purpose of further speeding up LTE. In addition, in the 3GPP, specifications of a succession system of the LTE called 5th generation (5G) New Radio (NR) or Next Generation (NG) have been studied.

In addition, in the 3GPP, Multi-Radio Dual Connectivity (MR-DC) in which a user equipment (UE) is simultaneously connected to a plurality of nodes (radio base stations) that can use different radio access technologies (RAT), specifically, a master node (MN) and a secondary node (SN) has been defined (see Non Patent Literature 1).

In a case of configuring the MR-DC, the UE first establishes a connection with a desired node in a radio resource control layer (RRC layer) to become a connected state (RRC Connected). Subsequently, a network transmits an instruction signal (for example, RRC Connection Reconfiguration) to the UE through a master cell group (MCG) including the desired node (corresponding to the MN), and configures a secondary cell group (SCG) including the SN for the UE.

In addition, in a case of releasing the MR-DC, similarly, the network releases the SCG (SN) configured for the UE by transmitting an instruction signal to the UE through the MCG.

### CITATION LIST

### Non Patent Literature

Non Patent Literature 1: 3GPP TS 37.340 V15.4.0, 3rd Generation Partnership Project; Technical Specification Group Radio Access Network; Evolved Universal Terrestrial Radio Access (E-UTRA) and NR; Multi-connectivity; Stage 2 (Release 15), 3GPP, December 2018

### SUMMARY OF INVENTION

However, the procedure for adding and releasing the SCG (SN) in the MR-DC described above has the following problems.

Specifically, in the configuration and the release of the MR-DC, transmission and reception of the instruction signal (RRC Connection Reconfiguration or the like) to and from the UE through the MCG (MN) are essential, and thus, there is a possibility that an amount of signaling in the RRC layer on an MCG side will increase.

When the amount of signaling in the RRC layer on the MCG side increases, transmission and reception of other user plane signals or the like that are not related to the MR-DC are adversely affected, resulting in a decrease in performance of a radio access network (RAN) on the MCG side.

For example, in a case of E-UTRA-NR Dual Connectivity (EN-DC), an instruction signal related to the MR-DC is transmitted and received on an E-UTRA (LTE) side, and thus, there is a possibility that a data rate of the UE connected to the E-UTRA will decrease.

In order to solve such a problem, it is preferable that the UE directly transmits a connection request to the SN not through the MCG. However, the SN needs to retain related information of the UE, specifically, a UE Context in advance.

Therefore, an SN that can be selected by the UE and candidates of resources related to the SN are limited to the SN retaining the UE Context of the UE, such that there is a problem of insufficient scalability.

Therefore, the present invention has been made in view of such a situation, and an object of the present invention is to provide a user equipment that enables a connection based on a connection request to a new node (radio base station) such as a secondary node even in a case where the node does not recognize related information (UE Context) of the user equipment, and a radio base station corresponding to the user equipment.

An aspect of the present invention is a user equipment (UE 200) including: a transmitting unit (transmitting unit 210) and a control unit (control unit 230), in which the control unit determines whether or not a second node (gNB 100C) different from a first node (eNB 100A) to which the user equipment is connected retains related information (UE Context) indicating a situation of the user equipment, and the transmitting unit transmits a connection request with the second node to the second node even in a case where the second node does not retain the related information.

An aspect of the present invention is a radio base station (gNB 100C) including: a receiving unit (transmitting unit 110) and a control unit (control unit 130), in which the radio base station functions as a second node (gNB 100C) different from a first node (eNB 100A) to which a user equipment is connected, the receiving unit receives a connection request with the radio base station from the user equipment, and the control unit executes acquisition processing of related information (UE Context) indicating a situation of the user equipment according to the connection request received by the receiving unit.

### BRIEF DESCRIPTION OF DRAWINGS

FIG. 1 is an overall schematic configuration diagram of a radio communication system 10.

FIG. 2 is a functional block configuration diagram of a UE 200.

FIG. 3 is a functional block configuration diagram of a gNB 100B and a gNB 100C.

FIG. 4 is a diagram illustrating a communication sequence related to addition of a secondary cell group (SCG) by UE 200 initiative.

FIG. 5 is a diagram illustrating a conventional communication sequence related to addition of an SCG (secondary node (SN)) at the start of E-UTRA-NR Dual Connectivity (EN-DC).

FIG. 6 is a diagram illustrating an overall operation flow of the UE 200 related to the addition of the SCG (SN).

FIG. 7 is a diagram illustrating a communication sequence related to addition of an SCG by the UE 200 and the gNB 100C that does not retain a UE Context of the UE 200.

FIG. 8 is a diagram illustrating an example of a hardware configuration of an eNB 100A, the gNB 100B, the gNB 100C, and the UE 200.

### DESCRIPTION OF EMBODIMENTS

Hereinafter, embodiments will be described with reference to the drawings. Note that the same functions or configurations will be denoted by the same or similar reference numerals, and a description thereof will be appropriately omitted.

### (1) Overall Schematic Configuration of Radio Communication System

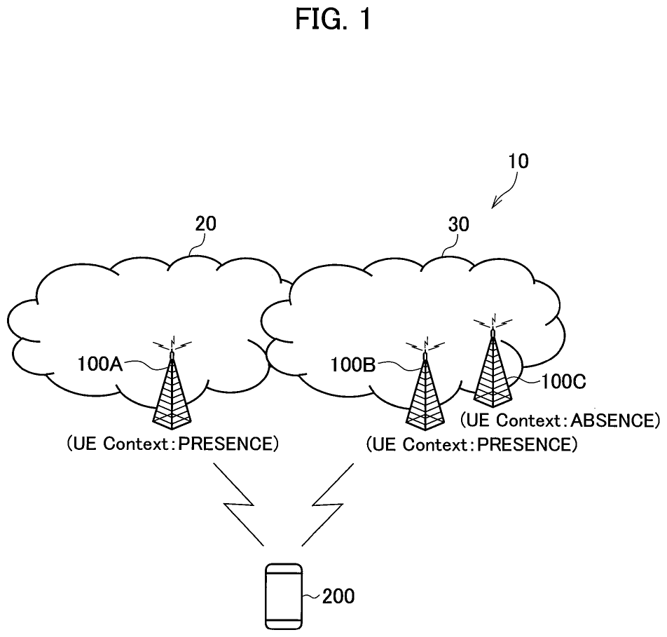

FIG. 1 is an overall schematic configuration diagram of a radio communication system 10 according to the present embodiment. The radio communication system 10 is a radio communication system according to Long Term Evolution (LTE) and 5th generation (5G) New Radio (NR). Note that the LTE may be referred to as 4th generation (4G) and the NR may be referred to as 5G.

The radio communication system 10 includes an Evolved Universal Terrestrial Radio Access Network 20 (hereinafter, referred to as an E-UTRAN 20) and a Next Generation-Radio Access Network 30 (hereinafter, referred to as an NG RAN 30). In addition, the radio communication system 10 includes a user equipment 200 (hereinafter, referred to as a UE 200).

The E-UTRAN 20 includes an eNB 100A, which is a radio base station according to the LTE. The NG RAN 30 includes a gNB 100B and a gNB 100C, which are radio base stations according to the 5G (NR). Note that the E-UTRAN 20 and the NG RAN 30 (or the eNB 100A, the gNB 100B, or the gNB 100C) may be simply referred to as a network.

The eNB 100A, the gNB 100B, the gNB 100C, and the UE 200 can support carrier aggregation (CA) that uses a plurality of component carriers (CCs), dual connectivity (DC) that simultaneously transmits component carriers between a plurality of NG-RAN nodes and the UE, and the like.

The eNB 100A, the gNB 100B, the gNB 100C, and the UE 200 perform radio communication through a radio bearer, specifically, Signalling Radio Bearer (SRB) or Data Radio Bearer (DRB).

In the present embodiment, Multi-Radio Dual Connectivity (MR-DC) in which the eNB 100A constitutes a master node (MN), and the gNB 100B or the gNB 100C constitutes a secondary node (SN), specifically, E-UTRA-NR Dual Connectivity (EN-DC) is executed. In the present embodiment, the eNB 100A constitutes a first node, and the gNB 100B or the gNB 100C constitutes a second node.

That is, the UE 200 supports dual connectivity in which the UE 200 is connected to the first node (eNB 100A) and the second node (gNB 100B or gNB 100C).

In addition, in the present embodiment, the gNB 100C (radio base station) functions as the second node different from the eNB 100A to which the UE 200 is connected.

The eNB 100A is included in a master cell group (MCG), and the gNB 100B (or the gNB 100C) is included in a secondary cell group (SCG). That is, the gNB 100B (or the gNB 100C) is an SN contained in the SCG.

In the present embodiment, resources on an MCG side are not used in an addition procedure of the SCG (SN) executed by the UE 200 in order to start the MR-DC (EN-DC). Specifically, selection and elimination of an SCG cell are executed without using a signal of a radio resource control layer (RRC layer) on the MCG side.

In addition, as illustrated in FIG. 1, the eNB 100A and the gNB 100B have related information (UE Context) indicating a situation of the UE 200, but the gNB 100C does not have (retain) the UE Context.

### (2) Functional Block Configuration of Radio Communication System

Next, a functional block configuration of the radio communication system 10 will be described. Specifically, functional block configurations of the gNB 100B and the UE 200 will be described. Note that, for convenience of explanation, a functional block configuration of the UE 200 will be described.

In addition, in a description of the functional block configuration, an outline of functions of each device will be described, and details of operations of each device will be described later.

### (2.1) UE 200

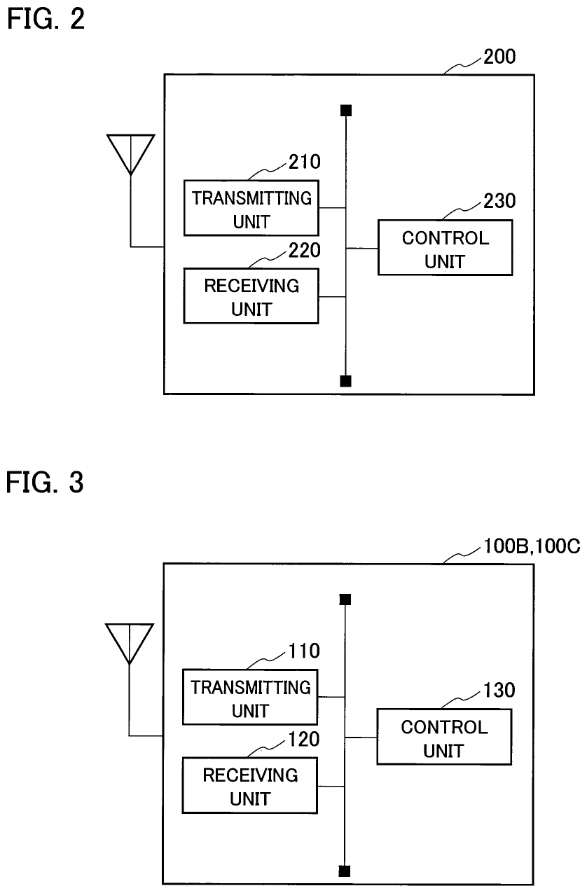

FIG. 2 is a functional block configuration diagram of the UE 200. As illustrated in FIG. 2, the UE 200 includes a transmitting unit 210, a receiving unit 220, and a control unit 230.

The transmitting unit 210 transmits an uplink signal (UL signal) according to the LTE or the NR. In particular, in the present embodiment, the transmitting unit 210 transmits a connection request with the gNB 100B (or gNB 100C, the same applies hereinafter) different from the eNB 100A to which the UE 200 is connected, to the gNB 100B, in accordance with the start of the MR-DC.

Further, the transmitting unit 210 can transmit the connection request with the gNB 100B to the gNB 100B based on a parameter selected by the control unit 230, specifically, a parameter used for connection with the gNB 100B at the time of executing the MR-DC.

Examples of the parameter used for the connection with the gNB 100B can include a radio access technology (RAT) of a cell (radio base station) of a connection destination, a frequency (bandwidth), capability information (UE Capability) of the UE 200, and the like, but details thereof will be described below.

In addition, the transmitting unit 210 transmits a connection request with the gNB 100C to the gNB 100C, even in a case where the gNB 100C does not retain the related information indicating the situation of the UE 200.

The related information indicating the situation of the UE 200 is typically information called a UE Context, and includes capability information (UE Capability) of the UE 200 and information on a configuration state (such as a radio resource, a security context, and a radio bearer) of the UE 200. The gNB 100C can execute processing related to the connection request described above by acquiring and retaining the UE Context of the UE 200.

The receiving unit 220 receives a downlink signal (DL signal) according to the LTE or the NR. In particular, in the present embodiment, the receiving unit 220 receives a connection request from the gNB 100B.

Specifically, the receiving unit 220 receives a connection request with the gNB 100B (SN) in accordance with the start of the MR-DC by the UE 200 from the gNB 100B. That is, the connection request is transmitted from the gNB 100B to the UE 200 by network initiative rather than UE 200 initiative. In the present embodiment, the UE 200 can transmit the connection request with the SN to the SN, and the gNB 100B can also transmit the connection request with the SN to the UE 200.

In addition, the receiving unit 220 can monitor predetermined resources (frequency, time and the like) in which the connection request is transmitted from a network side based on an instruction from the control unit 230.

The control unit 230 performs control on the UL signal transmitted by the transmitting unit 210 and the DL signal received by the receiving unit 220.

In the present embodiment, the control unit 230 starts the connection with the gNB 100B according to the transmission of the connection request with the gNB 100B (SN) different from the eNB 100A (MN) to which the UE 200 is connected, to the gNB 100B by the transmitting unit 210, in accordance with the start of the MR-DC.

Alternatively, the control unit 230 starts the connection with the gNB 100B according to the reception of the connection request (that is, the network initiative) from the gNB 100B (SN) different from the eNB 100A (MN) to which the UE 200 is connected, by the receiving unit 220, in accordance with the start of the MR-DC.

Specifically, the control unit 230 executes connection processing between the UE 200 and the gNB 100B, and establishes connection or the like of an RRC layer.

In addition, the control unit 230 selects a parameter used for the connection with the gNB 100B. As described above, the parameter is the radio access technology (RAT) of the cell (radio base station) of the connection destination, the frequency (bandwidth), the capability information (UE Capability) of the UE 200, and the like, but a connection procedure with the gNB 100B using the parameter will be described later.

In a case where the connection request with the gNB 100B is transmitted from the network side by the network initiative, the control unit 230 can cause the receiving unit 220 to monitor the predetermined resources (frequency, time and the like) in which the connection request is transmitted from the gNB 100B.

Further, the control unit 230 can start the connection with the gNB 100B in a case where the receiving unit 220 receives the connection request in the predetermined resources from the gNB 100B (network side).

In addition, the control unit 230 determines whether or not the gNB 100C different from the eNB 100A to which the UE 200 is connected retains the related information indicating the situation of the UE 200, specifically, the UE Context.

The control unit 230 causes the transmitting unit 210 to transmit the connection request with the gNB 100C to the gNB 100C even in a case where the gNB 100C does not retain the UE Context of the UE 200.

In a case where the control unit 230 transmits the connection request in such a state, that is, in a state where the gNB 100C does not retain the UE Context of the UE 200, the control unit 230 transmits the connection request through a common control channel (CCCH). Since the UE Context of the UE 200 is not required for reception of the CCCH, the gNB 100C that does not retain the UE Context of the UE 200 can also recognize that the connection request is transmitted by the UE 200.

(2.2) gNB 100B and gNB 100C

FIG. 3 is a functional block configuration diagram of the gNB 100B and the gNB 100C. As illustrated in FIG. 3, the gNB 100B and the gNB 100C include a transmitting unit 110, a receiving unit 120, and a control unit 130. Note that the eNB 100A also has a structure that is substantially the same as that of the gNB 100B and the gNB 100C except that a communication manner is different from that of the gNB 100B and the gNB 100C.

The transmitting unit 110 transmits a DL signal according to the NR. In particular, in the present embodiment, the transmitting unit 110 transmits a connection request between the UE 200 and the gNB 100B (or the gNB 100C, the same applies hereinafter) (SN) toward the UE 200 in a case where the connection request is transmitted from the network side in accordance with the start of the MR-DC by the network initiative.

The receiving unit 120 receives a UL signal according to the NR. In particular, in the present embodiment, the receiving unit 120 receives a connection request with the gNB 100B (SN) transmitted from the UE 200. That is, the receiving unit 120 receives a connection request with a radio base station transmitted from the UE 200.

In particular, in a case of the gNB 100C that does not retain the UE Context of the UE 200, the receiving unit 120 receives a connection request from the UE 200 transmitted through a common control channel (CCCH).

The control unit 130 performs control on the UL signal transmitted by the transmitting unit 110 and the DL signal received by the receiving unit 120.

In particular, in the present embodiment, the control unit 130 performs control related to the transmission of the connection request with the gNB 100B (SN) by the transmitting unit 110 and control related to the reception of the connection request with the gNB 100B (SN) by the receiving unit 120.

Specifically, the control unit 130 starts connection with the UE 200 according to the transmission of the connection request with the gNB 100B (SN) to the UE 200 or reception of the connection request with the gNB 100B (SN) from the UE 200.

More specifically, the control unit 130 executes connection processing between the UE 200 and the gNB 100B, and establishes connection or the like of an RRC layer.

In addition, the control unit 130 executes acquisition processing of the UE Context of the UE 200 according to the connection request received by the receiving unit 120. Specifically, the control unit 130 executes the acquisition processing of the UE Context of the UE 200 according to the connection request received through the CCCH. Note that an acquisition method (Context Fetch) of the UE Context will be described later.

### (3) Operation of Radio Communication System

Next, an operation of the radio communication system 10 will be described. Specifically, an addition operation of an SCG by UE 200 initiative according to the start of MR-DC (EN-DC), and an addition operation of an SCG in a case where a node (radio base station) added as an SN to the SCG does not retain the UE Context of the UE 200 will be described.

As described above, in the present embodiment, resources on the MCG (LTE) side are not used in an addition procedure of the SCG and an SCG cell (SN) executed by the UE 200 in order to start the MR-DC (EN-DC). That is, an instruction signal or the like related to the connection request with the gNB 100B (SN) is transmitted and received only within the NG RAN 30.

(3.1) Addition of SCG by UE 200 Initiative

In a case of addition of the SCG by the UE 200 initiative, the connection request with the gNB 100B (SN) is transmitted from the UE 200 to the gNB 100B. Hereinafter, a related communication sequence and an operation flow of the UE 200 will be described.

(3.1.1) Communication Sequence

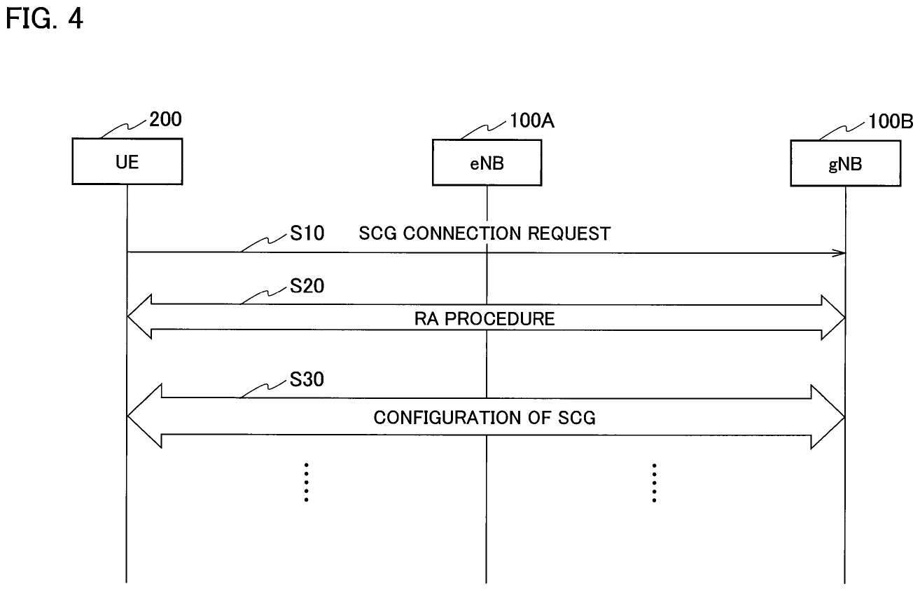

FIG. 4 illustrates a communication sequence related to addition of the SCG by the UE 200 initiative. As illustrated in FIG. 4, the UE 200 transmits a connection request (SCG connection request in the drawing) to the gNB 100B in order to add the SCG (SN) in accordance with the start of the MR-DC (S10). Here, it is assumed that the gNB 100B is selected as the SN. A selection method of the SN (SCG cell) will be described later.

When the SCG connection request is accepted by the gNB 100B, the UE 200 and the gNB 100B execute a random access procedure (RA procedure) (S20). Note that the RA procedure is the same as that defined in 3GPP TS38.300, TS38.321 and the like.

When the RA procedure is completed, the UE 200 and the gNB 100B execute configuration of the SCG (S30). Specifically, the UE 200 and the gNB 100B execute establishment of a connection in an RRC layer (RRC Connection), or the like.

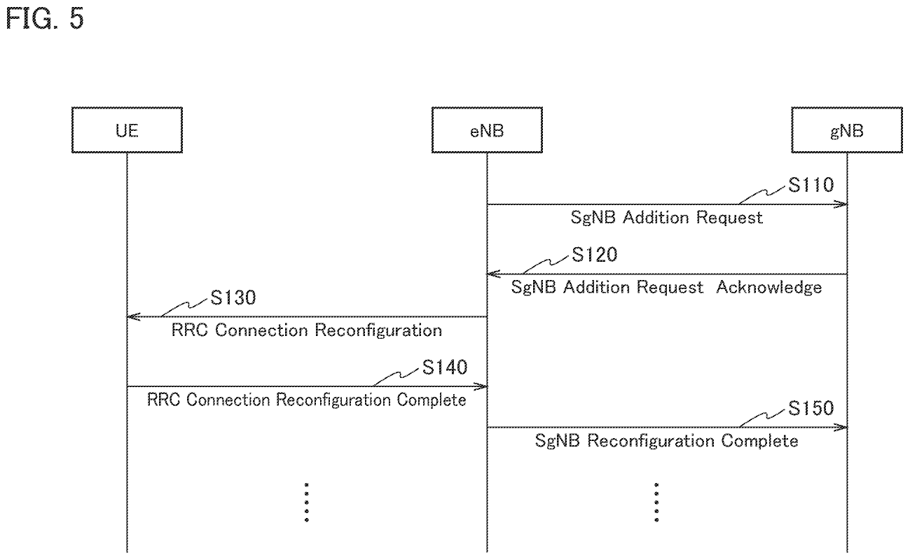

As such, the MCG (eNB 100A) side is not involved in the addition of the SCG at all. Here, FIG. 5 illustrates a conventional communication sequence related to addition of an SCG (secondary node (SN)) at the start of E-UTRA-NR Dual Connectivity (EN-DC). This communication sequence is defined in 3GPP T537.340.

As illustrated in FIG. 5, an eNB (MN) transmits a request for adding an SN (SgNB) to a gNB, and receives an acknowledgment for the request from the gNB (S110 and S120).

The eNB transmits a configuration change request in the RRC layer, specifically, an RRC Connection Reconfiguration (instruction signal) to the UE according to reception of the acknowledgment from the gNB, and receives a completion response to the configuration change request, specifically, an RRC Connection Reconfiguration Complete, from the UE (S130 and S140).

Further, the eNB transmits a completion report indicating that a configuration change related to the addition of the SN (SgNB) is completed to the gNB according to the reception of the completion response (S150).

As such, in the conventional communication sequence related to the addition of the SCG (SN), resources on the MCG (eNB) side are frequently used.

(3.1.2) Operation Flow of UE 200

Next, an operation flow related to addition of the SCG (SN) by the UE 200 will be described.

(3.1.2.1) Overall Operation Flow

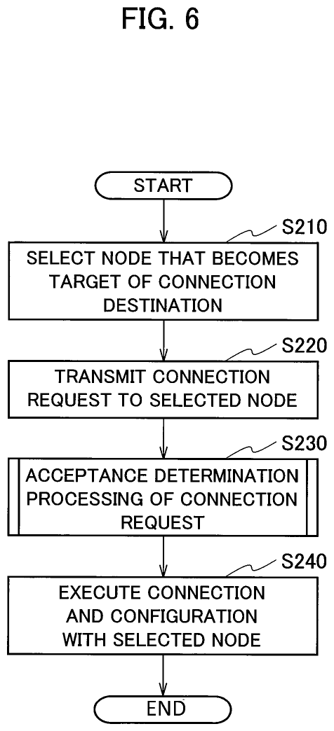

FIG. 6 illustrates an overall operation flow of the UE 200 related to the addition of the SCG (SN). As illustrated in FIG. 6, the UE 200 selects a node that becomes a target of a connection destination, specifically, a candidate for the SN (S210).

The UE 200 selects an SCG cell (for example, SpCell) that becomes a target, but may select the cell (including a frequency) that becomes the candidate for the SN based on any one or a combination of the following references.
Follow a selection method of a cell in an RRC IDLE state or an INACTIVE state of the UE 200
RAT of cell or frequency (bandwidth)
Frequency/cell on MCG side and UE Capability such as band combination supported by UE 200
Cell quality or Numerology
   Note that examples of the cell quality can include Channel State Information (CSI), a Signal-to-Interference plus Noise power Ratio (SINR), a Signal to Noise Ratio (SNR), Reference Signal Received Power (RSRP), Reference Signal Received Quality (RSRQ), and the like. In addition, the Numerology is defined in 3GPP TS38.300, and corresponds to one subcarrier spacing in a frequency domain.
QoS of data transmitted and received by UE 200
Frequency/congestion degree of cell

Note that the “congestion degree” or “Physical Resource Block (PRB) usage” may be broadcast by broadcasting information, or the congestion degree may be determined based on signal intensity or an amount of interference of the frequency.

In addition, an SN (gNB), a frequency, a cell, a Bandwidth part (BWP), and a beam (for example, an SS/PBCH Block (SSB), a CSI-RS, and a Transmission configuration indication (TCI)) selected by the UE 200 may be restricted in advance by a network.

Note that an instruction of such a restriction may be performed in a state where the MR-DC is not executed or may be performed at the time of initial MR-DC configuration. Alternatively, the instruction may be performed in the RRC IDLE state or the INACTIVE state of the UE 200.

Further, the SN (gNB), the frequency, the cell, the BWP, and the beam selected by the UE 200 may be given a priority in advance by the network.

The UE 200 selects the node that becomes the target based on such references, and transmits a connection request (SCG connection request) to the selected node (gNB 100B) (S220).

Specifically, the UE 200 can execute a connection request for the node (gNB 100B) selected by the following method.
Transmit the SCG connection request message through an UL

For example, RRC (such as SRB3), Medium Access Control Element (MAC CE), and physical layer (L1) signals may be used.
Execute an RA procedure (or a Scheduling request) for the SN and transmit an identifier (this identifier is implicitly equivalent to a connection request) of the UE 200

Note that, as the identifier of the UE 200, a Cell Radio Network Temporary Identifier (C-RNTI), an International Mobile Subscriber Identity (IMSI), an International Mobile Equipment Identity (IMEI), Network Slice Selection Assistance Information (NSSAI), and the like, can be used.

In addition, resources (for example, a frequency, a time, a random access preamble) for the RA procedure may be individually allocated in advance. In this case, the RA procedure is a contention-free RA procedure.

A timing at which the UE 200 is connected to the SN, that is, a timing at which the connection request is transmitted may be any one of the following timings.
Case where a frequency/cell/BWP that meets the selection references described above is found

Examples of this case can include a case where the SN is selected based on measurement of cell quality by the UE 200 and a case where measurement configuration of the SN is configured and a measurement result based on a content of the measurement configuration satisfies the selection reference.
Generation of UL data or reception of DL data
Generation of UL data or reception of DL data in a specific QoS flow
Generation of UL data or reception of DL data in a specific communication service (for example, motion picture playback) (detected by Deep Packet Inspection (DPI) or cooperation with an operating system (OS))
Case where an expected data amount or a communication speed has exceeded or exceeds a threshold value

For example, it is possible to use an HTTP header Content-size, a connection destination host, a URL, a process that has started a socket, and information of a socket API and estimate and determine “a data amount of communication generated from them”.

Change in Transmission Power of UE 200

A Power headroom and a maximum value (instantaneous value or average value) of transmission power can be used for detection of the change. Alternatively, the change may be detected in units of a component carrier (CC), an UL carrier, or a BWP, and in a case where there are a plurality of targets, the sum or an average of the plurality of targets may be used for detection of the change.

Detection of Internal State Change of UE 200

Examples of this can include a residual amount of battery, a temperature of a device (UE 200), a processing load other than communication (or including communication), and a human body distance (that may be a back off value for satisfying a specific absorption rate (SAR), or the like).

Periodic Trigger (Once Per 10 Seconds)

In addition, the UE 200 may notify the SN of the following information together with the connection request.
Identification information (for example, E-UTRAN Cell Global Identifier (E-CGI)) of MCG (MN)
Quality information (for example, measurement report, CSI, and PHR) of cell performing connection and neighboring cells
Identifiers (for example, Cell ID, BWP ID, serving cell identifier (ServCellIndex), gNB (SN) identifier (CGI or the like), and Public Land Mobile Network (PLMN) identifier)) of connected SCG cell (SN) or related resources
Connection request reason (for example, resumption of UL data, S-RLF, or the like)
UL data retention amount (transmission point in time of connection request or estimated value of data amount generated in the future)

Then, the UE 200 executes an acceptance determination processing for determining whether or not the transmitted connection request is accepted by the network, specifically, the gNB 100B (S230).

Details of the acceptance determination processing will be described later. Here, it is assumed that the connection request is accepted.

The UE 200 executes connection and configuration with the selected node (gNB 100B) (S240). Specifically, the UE 200 executes the RA procedure with the gNB 100B and executes the establishment of the RRC Connection, or the like, as described above.

Specifically, the UE 200 executes the connection and the configuration with the gNB 100B based on a notification from the gNB 100B for the transmitted connection request. Note that the notification may be transmitted through the common control channel (CCCH) or may be transmitted through a dedicated control channel (DCCH) or an SRB (for example, SRB3).

Note that in a case of using the SRB, in order to make states of layer 2 coincide with each other between the UE 200 and the gNB 100B (SN), the SRB may be reconfigured (newly configured or reestablished). In addition, when the SRB is reconfigured, configuration of a default may be applied.

Further, the UE 200 may notify the eNB 100A (MN) of an acceptance result of the connection request. In this case, scheduling (for example, a transmission node) of user plane data for the UE 200 may be changed based on the notification.

(3.2) Addition of SCG in case where node of connection destination does not retain UE Context

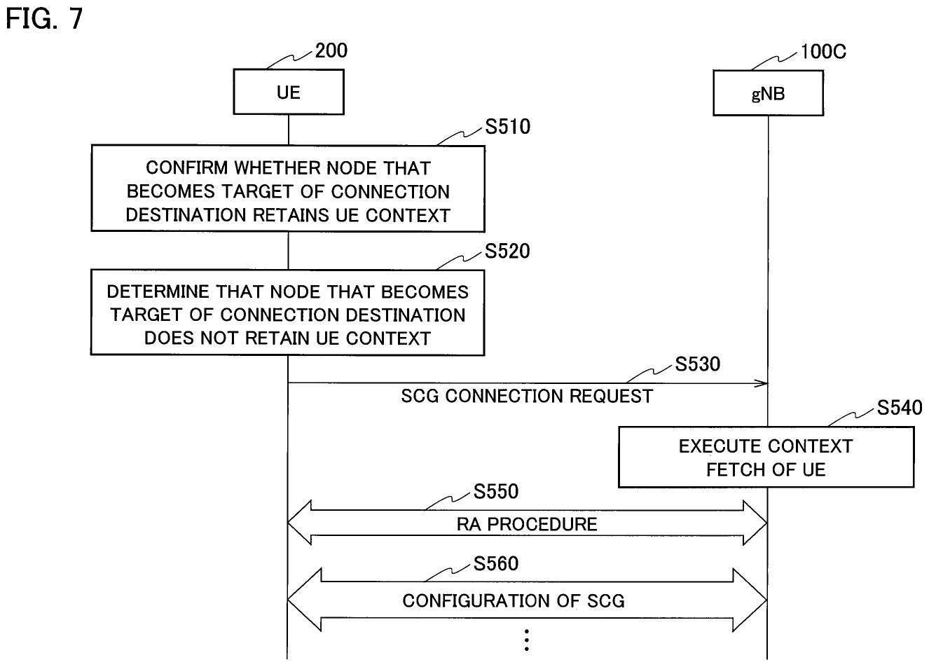

FIG. 7 illustrates a communication sequence related to addition of the SCG by the UE 200 and the gNB 100C that does not retain the UE Context of the UE 200.

As illustrated in FIG. 7, the UE 200 confirms whether or not a node (gNB 100C) that becomes a target of a connection destination, specifically, a candidate for the SN retains the UE Context of the UE 200 (S510) in order to add an SCG (SN) in accordance with the start of the MR-DC.

More specifically, the UE 200 determines whether or not the gNB 100C (including a frequency, a cell, a BWP, and a beam associated with the gNB 100C) selected as the target of the connection destination retains the UE Context of the UE 200.

The UE Context may be included in advance in broadcasting information and be notified from a network to each node including the gNB 100C or may be individually notified to a specific node in a format such as a white list or a black list.

In a case where the UE Context is notified using the broadcasting information, the UE Context may be notified in units of a gNB group or an area in which the UE Context is retained. In addition, a plurality of gNB groups or areas may be configured. In this case, for example, which UE Context should be referred to may be specified using an identifier for identifying the UE Context.

Here, the UE 200 determines that the gNB 100C selected as the target of the connection destination does not retain the UE Context of the UE 200 (S520).

In the present embodiment, even in such a case, the UE 200 transmits a connection request (SCG connection request) to the gNB 100C (S530).

Specifically, the UE 200 requests connection to the gNB 100C (including a frequency, a cell, a BWP, and a beam associated with the gNB 100C). Note that the connection request is transmitted through the CCCH, as described above.

Specifically, information constituting the connection request is transmitted with being included in a CCCH Service Data Unit (SDU). The CCCH is a channel that can be used in a case where the UE 200 in the RRC IDLE state or the INACTIVE state requests connection to a node.

In addition, the connection request may include identifiers of the MN (eNB 100A) and the SN (in a case of being already in an MR-DC state).

Note that in a case where the gNB 100C retains the UE Context of the UE 200, an addition operation of the SCG by the UE 200 initiative described above can be executed.

When the gNB 100C receives the connection request, the gNB 100C executes Context Fetch of the UE 200 based on the information from the UE 200 (S540).

In the Context Fetch, acquisition of the UE Context, for example, capability information (UE Capability) of the UE 200 and information on a configuration state (such as a radio resource, a security context, and a radio bearer) of the UE 200 and transfer of the information are executed.

When the Context Fetch is completed, the UE 200 and the gNB 100C execute an RA procedure and configuration of the SCG, similar to the communication sequence illustrated in FIGS. 4 (S550 and S560).

(3.3) Others

The operation related to the connection request described above may be executed only in a case where there is an instruction, permission, or configuration from the network.

Further, in a case where there are a plurality of options or conditions, the plurality of options or conditions may be instructed, permitted, or configured together. Alternatively, the UE Context may be specified by a list (for example, a white list or a black list) in which true and false are collected.

In addition, also in a case where there are a plurality of frequencies (that may be frequency ranges), CCs, serving cells, UL carriers, or BWPs that the UE 200 corresponds to, they may be instructed, permitted, or configured together or may be instructed, permitted, or configured individually.

The operation related to the connection request described above may be executed in a case where the UE 200 is in the following state.
Non-MR-DC state
MR-DC state (UE 200 autonomously changes SpCell)
State where S-RLF occurs in MR-DC state

In addition, in a case where the operation related to the connection request described above is executed in the MR-DC state, configuration information (configuration) of an old SCG may be dropped at the time of the connection request. Further, in this case, the SN may be notified that the configuration information of the old SCG is dropped, or the configuration information of the old SCG may be dropped at the time of receiving configuration information of a new SCG from the network.

In a case where the connection request is repeated plural times, a different operation among the operation examples described above may be executed for each connection request.

In addition, the UE 200 may notify the network of the fact that the operation described above is possible as capability information (UE capability). Note that the notification may be performed in units of the UE 200 or may be performed in units of a RAT, a Band combination, a frequency band, or a BWP.

### (4) Action and Effect

According to the embodiment described above, the following effects can be obtained. Specifically, the UE 200 determines whether or not the gNB 100C different from the eNB 100A to which the UE 200 is connected retains the UE Context of the UE 200 in accordance with the start of the MR-DC. In addition, the UE 200 transmits the connection request with the gNB 100C to the gNB 100C even in the case where the gNB 100C does not retain the UE Context.

Further, in a case where the gNB 100C receives the connection request, the gNB 100C executes acquisition processing (Context Fetch) of the UE Context.

For this reason, even in the case where the gNB 100C does not retain the UE Context, autonomous connection with the SN selected by the UE 200 can be successfully performed. Thus, even in a case where a new node (radio base station) such as the SN does not recognize the UE Context of the UE 200, the UE 200 can perform connection based on a connection request to the node (gNB 100C).

In addition, according to the present embodiment, the SN that can be selected by the UE 200 and a candidate for a resource related to the SN are not limited to the SN retaining the UE Context of the UE 200, and thus does not hinder scalability of the entire network.

In the present embodiment, the UE 200 can transmit the connection request through the CCCH. The CCCH is a common control channel used in common for a plurality of UEs, and the gNB 100C that does not retain the UE Context of the UE 200 can also recognize that the connection request is transmitted by the UE 200. For this reason, even in the case where the gNB 100C does not retain the UE Context, the gNB 100C can certainly and quickly recognize a content of the connection request.

In the present embodiment, the operation is executed in order to add the SN included in the SCG in the MR-DC. For this reason, when the UE 200 starts the MR-DC, the UE 200 can add the SN without adversely affecting the MCG side.

### (5) Other Embodiments

Although the contents of the present invention have been described hereinabove with reference to the embodiments, it is obvious to those skilled in the art that the present invention is not limited to these descriptions, and can be variously modified and improved.

For example, the addition of the SN in the MR-DC has been described by way of example in the embodiment described above, but a similar operation may be performed at the time of releasing the SN. That is, instead of the connection request, the UE 200 may transmit (or receive) a release request of the SN and start the release of the SN according to the release request.

In addition, the operation described above is not limited to the MR-DC, and may be applied to handover (cell reselection) of the UE 200 to another cell (radio base station), addition of a secondary cell (SCell) in carrier aggregation (CA), addition of a BWP, or the like.

Further, in the embodiment described above, the UE 200 determines whether or not the gNB 100C retains the UE Context (related information) indicating the situation of the UE 200, but may be paraphrased as follows.

Specifically, it may be paraphrased as “the UE 200 determines whether or not it is notified that the UE needs to notify predetermined information at the time of connection (or whether or not it is notified that notification is not necessary)” or may be paraphrased as “the UE 200 determines whether or not it is notified that the UE uses a predetermined signal (for example, a CCCH, a DCCH/SRB, or an MAC CE) at the time of connection”.

In addition, the MR-DC using different radio base stations (eNB 100A and gNB 100B) has been described by way of example in the embodiment described above, but the first node and the second node may be logical nodes or may be configured in the same radio base station (that is, MR-DC in the same radio base station).

In addition, the connection request is transmitted from the UE 200 or the gNB 100B in the non-MR-DC state in the embodiment described above, but the connection request may also be transmitted in a case where the UE 200 further adds the SN in the MR-DC state.

Further, the block diagrams (FIGS. 2 and 3) used for describing the embodiments illustrate blocks of functional unit. Those functional blocks (structural components) can be realized by a desired combination of at least one of hardware and software. A method for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (structural component) that causes transmitting may be called a transmitting unit or a transmitter. For any of the above, as explained above, the realization method is not particularly limited to any one method.

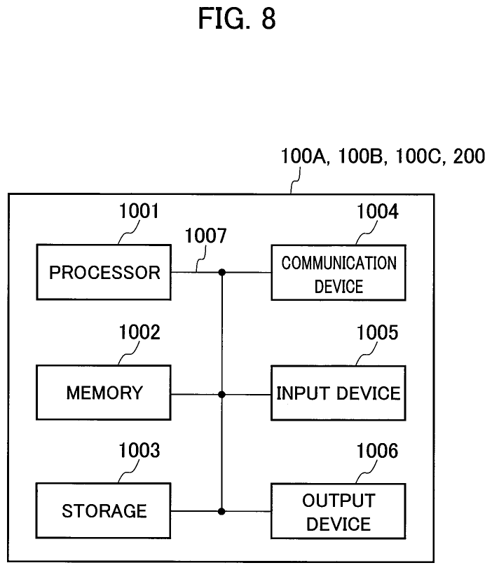

Furthermore, the eNB 100A, the gNB 100B, the gNB 100C, and the UE 200 (the device) explained above can function as a computer that performs the processing of the radio communication method of the present disclosure. FIG. 8 is a diagram illustrating an example of a hardware configuration of the device. As illustrated in FIG. 8, the device can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

The functional blocks (see FIGS. 2 and 3) of the device can be realized by any of hardware elements of the computer device or a desired combination of the hardware elements.

Moreover, the processor 1001 performs operation by loading a predetermined software (program) on hardware such as the processor 1001 and the memory 1002, and realizes various functions of the device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, an operation device, a register, and the like.

Moreover, the processor 1001 reads a program (program code), a software module, data, and the like from the storage 1003 and/or the communication device 1004 into the memory 1002, and executes various processes according to the data. As the program, a program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main storage device), and the like. The memory 1002 can store therein a program (program codes), software modules, and the like that can execute the method according to the embodiment of the present disclosure.

The storage 1003 is a computer readable recording medium and is configured, for example, with at least one of an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 can be constituted by a single bus or can be constituted by separate buses between the devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), higher layer signaling (for example, RRC signaling, Medium Access Control (MAC) signaling, broadcast information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, optical fiber cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be instructed by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), or a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the radio frequency domain, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 E-UTRAN
30 NG RAN
100A eNB
100B, 100C gNB
110 Transmitting unit
120 Receiving unit
130 Control unit
200 UE
210 Transmitting unit
220 Receiving unit
230 Control unit
1001 Processor
1002 Memory
1003 Storage
1004 Communication device
1005 Input device
1006 Output device
1007 Bus
1007 Bus

1. A user equipment comprising:
a transmitting unit and a control unit,
wherein the control unit determines whether or not a second node different from a first node to which the user equipment is connected retains related information indicating a situation of the user equipment, and
the transmitting unit transmits a connection request with the second node to the second node even in a case where the second node does not retain the related information.

2. The user equipment according to claim 1, wherein the transmitting unit transmits the connection request through a common control channel.

3. The user equipment according to claim 1, wherein the user equipment supports dual connectivity in which the user equipment is connected to the first node and the second node, and
the second node is a secondary node included in a secondary cell group.

4. A radio base station comprising:
a receiving unit and a control unit,
wherein the radio base station functions as a second node different from a first node to which a user equipment is connected,
the receiving unit receives a connection request with the radio base station from the user equipment, and
the control unit executes acquisition processing of related information indicating a situation of the user equipment according to the connection request received by the receiving unit.

5. The radio base station according to claim 4, wherein the receiving unit receives the connection request through a common control channel.

6. The user equipment according to claim 2, wherein the user equipment supports dual connectivity in which the user equipment is connected to the first node and the second node, and
the second node is a secondary node included in a secondary cell group.
